(19) United States
(12) Patent Application Publication
(10) Pub. No.: US 2024/0358576 A1
(43) Pub. Date: Oct. 31, 2024

(54) SafeNDry Crutch BOOTS

(71) Applicant: Jean Tahan, Montreal (CA)

(72) Inventor: Jean Tahan, Montreal (CA)

(21) Appl. No.: 18/309,729

(22) Filed: Apr. 28, 2023

(51) Int. Cl. A61H 3/02

(52) U.S. Cl. CPC A61H 3/0288; A61H 2201/0107

(57) ABSTRACT

SafeNDry Crutch Boots are innovative accessories designed to enhance the safety and convenience of crutch and cane users navigating winter-wet conditions and when transitioning to indoor dry floor surfaces upon boot removal, tips remain dry, therefore, there's no need for users to remove snow, ice and wipe tips dry before indoor use. This document provides a detailed specification, including descriptions, drawings, and claims. Traditional solutions involve, removing snow and ice, and wiping the crutch or cane tips dry before moving indoors or risk slip-fall and injury, a time-consuming and sometimes ineffective process. Thanks to the SafeNDry Crutch boots, user get better outdoor traction and dry tips upon boot removal indoors.

### 1. TECHNICAL FIELD

The invention relates to assistive devices (a winter boot) for crutch and cane users, specifically addressing challenges faced during winter-wet conditions and transitioning to indoor dry floors.

### 2. BACKGROUND

Crutch and cane users often encounter difficulties with outdoor traction and transitioning indoors with wet tips. SafeNDry Crutch Boots aim to solve these issues by providing a protective and functional accessory with great outdoor traction and upon boot removal indoors, tips remain safe and dry so there is no longer any need for users to remove snow, ice and wipe the tips dry before indoor use. Also, no need for users to clean puddles left behind by wet crutch tips on dry floors. The SafeNDry Crutch Boots can also convenient when shopping in stores, malls or any other indoor dry surfaces upon boot removal, users can remove the boots indoors without having the need to remove snow, ice and wipe their tips dry to avoid slip-fall and injury since tips remain dry covered by the boots, when transitioning indoors, boots are removed protecting tips from snow, ice, water.

### 3. SUMMARY

SafeNDry Crutch Boots consist of the following key components:

### 3.1. Material:

Waterproof Material: The boots are crafted from a durable, waterproof material to protect crutch and cane tips from moisture, snow, and ice.

### 3.2. Structure:

Anti-Slip Sole: An anti-slip rubber sole enhances stability on wet and icy surfaces.

### 3.3. Design:

Nylon Zipper and Velcro Strap: The boots feature a user-friendly design with a nylon zipper for easy installation and removal. A Velcro strap ensures a snug fit. A clip hook is also included in the package so users can easily hang the boots on their crutch-cane side wholes after removal when running errands in stores or shopping malls, restaurants, etc.

### 4. DRAWINGS

FIG. 1A is the front view of the boot

This illustration provides an overview of SafeNDry Crutch Boots front view

FIG. 1B is the side view of the boot

This illustration provides an overview of SafeNDry Crutch Boots side view

FIG. 1C is the back view of the boot

This illustration provides an overview of SafeNDry Crutch Boots back view

FIG. 1D is the sole view of the boot

This illustration provides an overview of SafeNDry Crutch Boots sole view

FIG. 1E is the SafeNDry Crutch Boots inside view

This illustration provides an overview of SafeNDry Crutch Boots inside view

FIG. 1F is the SafeNDry Crutch Boots installed on crutches and cane

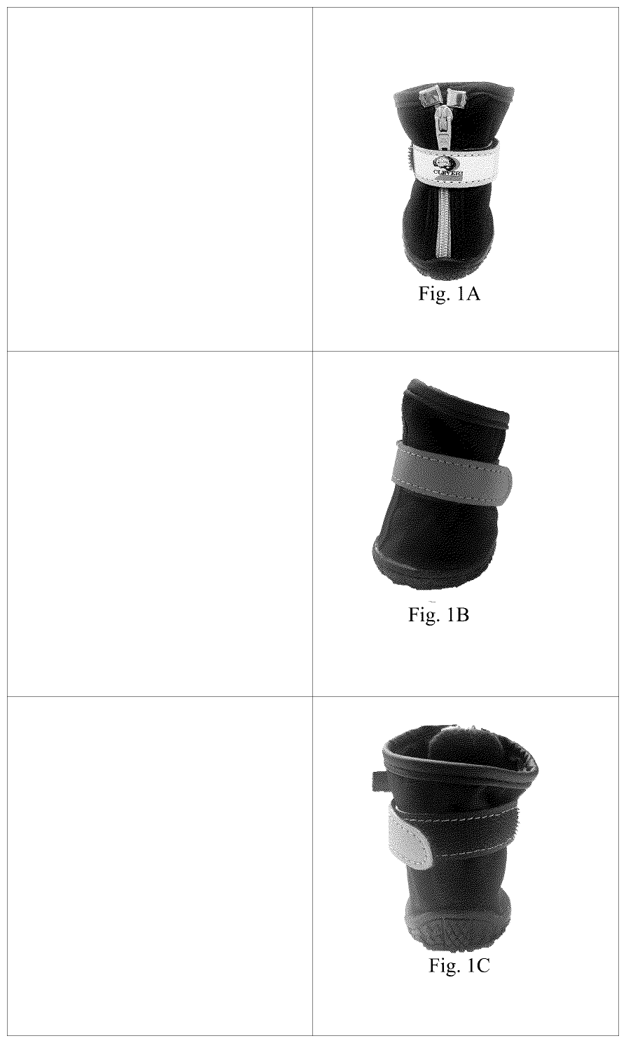

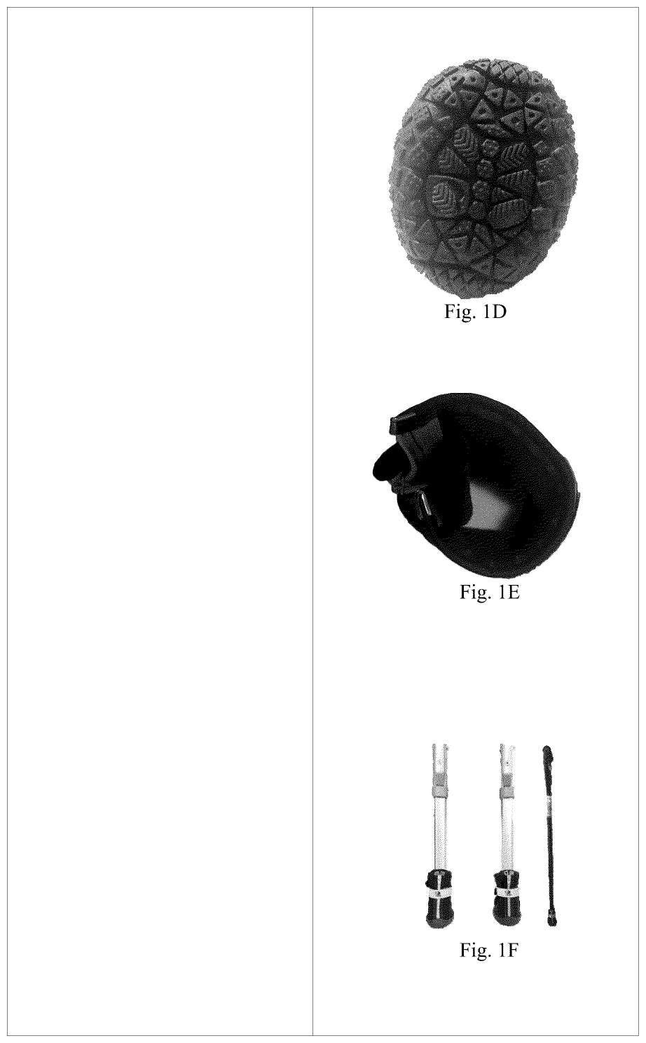

This illustration provides an overview of SafeNDry Crutch Boots installed on crutches and cane view

### 5. DETAILED DESCRIPTION

### 5.1. Waterproof Material:

The waterproof material ensures that crutch and cane tips remain dry, preventing slips and maintaining a secure grip.

### 5.2. Anti-Slip Sole:

The anti-slip rubber sole provides enhanced stability, making SafeNDry Crutch Boots suitable for various terrains.

### 5.3. Nylon Zipper and Velcro Strap:

The user-friendly design allows for easy installation and removal. The nylon zipper ensures a secure fit, and the Velcro strap adds an extra layer of stability.

### CONCLUSION

SafeNDry Crutch Boots represent a significant advancement in the field of assistive devices for crutch and cane users. The waterproof and anti-slip features, coupled with the user-friendly design, make these boots a valuable addition to winter mobility solutions and a big time-saver when transitioning to indoor dry floor surfaces upon boot removal, tips remain dry, so no need to remove snow, ice and wipe tips dry. Also, no need to clean puddles left behind by wet crutch tips on dry floors.

1. A waterproof exterior body made from waterproof elastic material.

2. An anti-slip rubber sole.

3. A front zipper with a Velcro strap

4. (canceled)

5. (canceled)

6. (canceled)

7. (canceled)

8. (canceled)

9. (canceled)

10. (canceled)
